(19) United States
(12) Patent Application Publication
(10) Pub. No.: US 2023/0401296 A1
(43) Pub. Date: Dec. 14, 2023

(54) HOLOGRAM PATTERN CONTENT DECONSTRUCTION

(71) Applicant: HEWLETT-PACKARD DEVELOPMENT COMPANY, L.P., Spring, TX (US)

(72) Inventors: Super Liao, Taipei (TW); Chia-Cheng Lin, Taipei (TW); Hsing-Hung Hsieh, Taipei (TW)

(73) Assignee: HEWLETT-PACKARD DEVELOPMENT COMPANY, L.P., Spring, TX (US)

(21) Appl. No.: 17/835,287

(22) Filed: Jun. 8, 2022

(51) Int. Cl. G06F 21/31; G09G 3/00; G09G 3/34; G02B 27/01

(52) U.S. Cl. CPC G06F 21/31; G09G 3/001; G09G 3/3413; G02B 27/0172; G09G 2370/00; G09G 2358/00; G09G 2354/00; G02B 2027/0178; G02B 2027/0174

(57) ABSTRACT

In an example in accordance with the present disclosure, a wearable extended reality (XR) system is described. The wearable XR system includes a transceiver to receive, from a host computing device, a hologram pattern of original content to be displayed. The wearable XR system also includes a display unit. The display unit includes 1) a pattern lens to display the hologram pattern in front of a red, green, blue (RGB) light source and 2) the RGB light source to emit red, green, and blue light towards the hologram pattern to deconstruct the hologram pattern to present the original content. The wearable XR system also includes an image director to reflect the decoded original content towards a user of the wearable XR system.

### BACKGROUND

Electronic devices include display screens to present information to a user. Examples of display screens include liquid crystal displays, light-emitting diode displays, and the like. Such devices are used in many areas of professional and everyday life throughout the world. These electronic devices and corresponding display screens are used to access and display a variety of information.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a wearable extended reality (XR) system for deconstructing a hologram pattern, according to an example of the principles described herein.

FIG. 2 depicts a user wearing the wearable XR system for deconstructing a hologram pattern, according to an example of the principles described herein.

FIG. 3 depicts a hologram pattern of original content to be presented on the wearable XR system, according to an example of the principles described herein.

FIGS. 4A and 4B, depict a wearable XR system for the deconstruction of a hologram pattern, according to an example of the principles described herein.

FIG. 5 depicts a flowchart of deconstructing a hologram pattern, according to an example of the principles described herein.

FIG. 6 depicts a wearable XR system for the deconstruction of a hologram pattern, according to an example of the principles described herein.

FIG. 7 depicts a flowchart of deconstructing a hologram pattern, according to an example of the principles described herein.

FIGS. 8A-8C depict the various modes of a host computing device and associated wearable XR system displays, according to an example of the principles described herein.

FIG. 9 depicts a non-transitory machine-readable storage medium for deconstructing a hologram pattern, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

As described above, electronic devices have widespread use in society. With the continued development of these devices, the use of electronic devices in society will continue to increase. The types of information that can be shared via these electronic devices are also expanding. The electronic devices may be used in public settings. For example, electronic devices and other devices with display screens are increasingly being used at kiosks to deliver services to the public in general. Moreover, electronic devices may be portable such that a user may use them in public settings such as airport terminals, restaurants, libraries, or any other public setting. While such electronic device usage is on the rise and enables more widespread use of such, some characteristics limit their more widespread use.

For example, in some cases, the information displayed to a user may be private and confidential, intended just for a certain individual or group of individuals. For example, a hospital kiosk may present, or prompt entry of, certain confidential medical information. It may be difficult to keep such information private, for example when the electronic device is in a public area.

While specific reference has been made to use in a hospital setting, such devices may be used in other public contexts. Another such example is an automated teller machine (“ATM”) into which a user enters financial information such as an access code to the user's financial accounts. In such cases, there is a possibility that the displayed information may be seen by unauthorized people who may use the information to the disadvantage of a person or persons to whom the information pertains.

There may be other circumstances in which it is desirable to maintain privacy of the information displayed on an electronic device. For example, laptops or notebook computers may be used in crowded public areas such as airports, train stations, or other public areas. Such devices may be used for personal matters, such as writing a letter or working on professional matters that may have sensitive or otherwise confidential information. When used in these areas, there is no guarantee that such information will remain private or confidential as passersby may be able to view the electronic device display screen and ascertain the information therein. More specifically, there may be a general concern that a nearby person, such as the person in the next airplane seat, may be reading the information on the laptop or notebook computer. If the computer or other electronic device is used in this way, sensitive data may be stolen or otherwise compromised. This concern may keep many people from using a laptop computer in many instances when its use would be particularly convenient.

Accordingly, the present specification describes devices for increasing a privacy level of content displayed on a display device. Specifically, content on a host computing device screen is encoded via a Fourier transformation into a hologram pattern. The Fourier transformation decomposes an image into the frequency domain whereas the original image before the Fourier transformation is in a spatial domain.

Following the Fourier transformation, the image is in a hologram pattern format, which is a scrambled format that is indiscernible to the human eye. The hologram pattern of an image may include a collection of red, blue, and green pixels, which may appear to be a random pattern with no discernible structure. Thus, no user can view or discern the content of the image by viewing the hologram pattern of the image.

However, upon interaction with red, green, and blue light waves, the hologram pattern is decomposed and the original content is rebuilt. As such, the hologram pattern is presented on a pattern lens of a wearable XR system. A red, green, blue (RGB) light source on the wearable XR system may be selectively activated to emit light towards the hologram pattern. The interaction of the colored light with the respective colored pixels in the hologram pattern decodes the associated color content. Decoded color sub-frames for each of red, green, and blue light are combined into one frame such that an intended user may view the uncoded frame, i.e., the original information. In an example, the original content is presented as a hologram to a user of the wearable XR system.

In a privacy mode, the RGB light source is not activated so a user sees either the hologram pattern in its scrambled format or does not see the holographic original content. However, upon activation of the RGB light source, the original content is presented. The interaction of the RGB light source with the hologram pattern separates the hologram pattern image into its constituent (red, green, and blue) parts and reconstructs the original image. If a user and/or wearable XR system is not authenticated, the RGB light source is not activated, and either the hologram pattern is displayed on the viewing lens of the wearable XR system, still in a user indiscernible format or the hologram pattern is not displayed on the pattern lens

Extended reality (XR) systems create an environment wherein a user can interact with real or digital objects within the environment. XR systems include virtual reality (VR) systems, augmented reality (AR) systems, and mixed reality (MR) systems. Such XR systems can include head-mounted displays (HMDs) to generate realistic images, sounds, and other human discernable sensations that simulate a user's physical presence in a virtual environment presented at the HMD. A VR system includes physical spaces and/or multi-projected environments. AR systems may include systems and devices that implement direct and/or indirect displays of a physical, real-world environment whose elements are augmented by computer-generated sensory input such as sound, video, graphics and/or global positioning system (GPS) data. MR systems merge real and virtual worlds to produce new environments and visualizations where physical and digital objects co-exist and interact in real time. For simplicity, VR systems, AR systems, and MR systems are referred to herein as XR systems.

Specifically, the present specification describes a wearable XR system. The wearable XR system includes a transceiver to receive, from a host computing device, a hologram pattern of original content to be displayed. The wearable XR system also includes a display unit that includes a pattern lens to display the hologram pattern in front of a red, green, blue (RGB) light source. The display unit also includes the RGB light source of the wearable XR system emits red, green, and blue light towards the hologram pattern to deconstruct the hologram pattern to present the original content. The display unit also includes an image director to direct the decoded original content towards the user of the wearable XR system.

The present specification also describes a method. According to the method, XR spectacles are paired with a host computing device. A hologram pattern of original content is presented onto a pattern lens of the XR spectacles. A user of the XR spectacles or the XR spectacles themselves are authenticated and responsive to authentication, an RGB light source is activated to emit light towards the hologram pattern to deconstruct the hologram pattern to present the original content.

The present specification also describes a non-transitory machine-readable storage medium encoded with instructions executable by a processor. The machine-readable storage medium comprising instructions to pair XR spectacles with a host computing device. The instructions are executable by the processor to determine a mode of the host computing device. Responsive to the host computing device being in a sharing mode, the instructions are executable by the processor to present original content of a host computing device on the XR spectacles. Responsive to the host computing device being in a privacy mode, the instructions are executable by the processor to 1) present a hologram pattern of the original content onto a pattern lens of the XR spectacles and 2) authenticate a user of the XR spectacles. Responsive to authentication of the user, the instructions are executable by the processor to activate an RGB light source to emit light towards the hologram pattern to deconstruct the hologram pattern to present the original content. Responsive to identifying an unauthenticated user, the instructions are executable by the processor to cause the processor to prevent deconstruction of the hologram pattern of the original content.

In summary, such a system, method, and machine-readable storage medium may, for example, 1) provide security and access rights to information displayed on a host computing device via a wearable XR system, 2) allow for customized selection of content to be encoded, 3) does not limit the viewing angle of secured content; 4) provide for both secured and unsecured content presentation on a single computing device screen; and 5) prevent unauthorized XR systems from viewing the encoded data. However, it is contemplated that the devices disclosed herein may address other matters and deficiencies in a number of technical areas, for example.

As used in the present specification and in the appended claims, the term “hologram pattern” refers to a pattern image that is created by applying a Fourier transformation, or other transformation, to original content to be displayed.

As used in the present specification and in the appended claims, the term “controller” refers to components that include a processor and a memory device. The processor includes the circuitry to retrieve executable code from the memory and execute the executable code. As specific examples, the controller as described herein may include machine-readable storage medium, machine-readable storage medium and a processor, an application-specific integrated circuit (ASIC), a semiconductor-based microprocessor, and a field-programmable gate array (FPGA), and/or other hardware device.

As used in the present specification an in the appended claims, the term “memory” includes a non-transitory storage medium, which machine-readable storage medium may contain, or store machine-usable program code for use by or in connection with an instruction execution system, apparatus, or device. The memory may take many forms including volatile and non-volatile memory. For example, the memory may include Random-Access Memory (RAM), Read-Only Memory (ROM), optical memory disks, and magnetic disks, among others. The executable code may, when executed by the respective component, cause the component to implement the functionality described herein. The memory may include a single memory element or multiple memory elements.

Further, as used in the present specification and in the appended claims, the term XR environment refers to that environment presented by the XR system and may include an entirely digital environment, or an overlay of a digital environment on a physical scene viewed by the user. For example, the XR environment may be a VR environment which includes physical spaces and/or multi-projected environments. AR environments may present direct and/or indirect displays of a physical, real-world environment whose elements are augmented by computer-generated sensory input such as sound, video, graphics and/or global positioning system (GPS) data. XR environments merge real and virtual worlds to produce new environments and visualizations where physical and digital objects co-exist and interact in real time.

As used in the present specification and in the appended claims, the term “a number of” or similar language is meant to be understood broadly as any positive number including 1 to infinity.

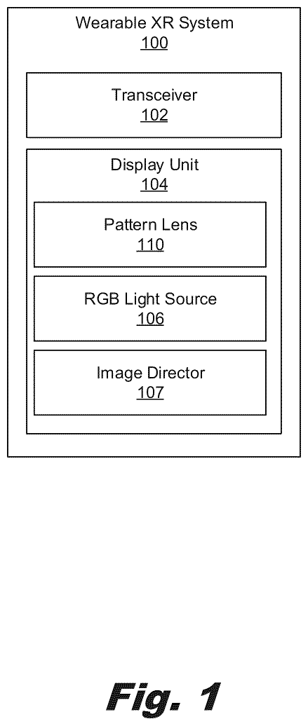

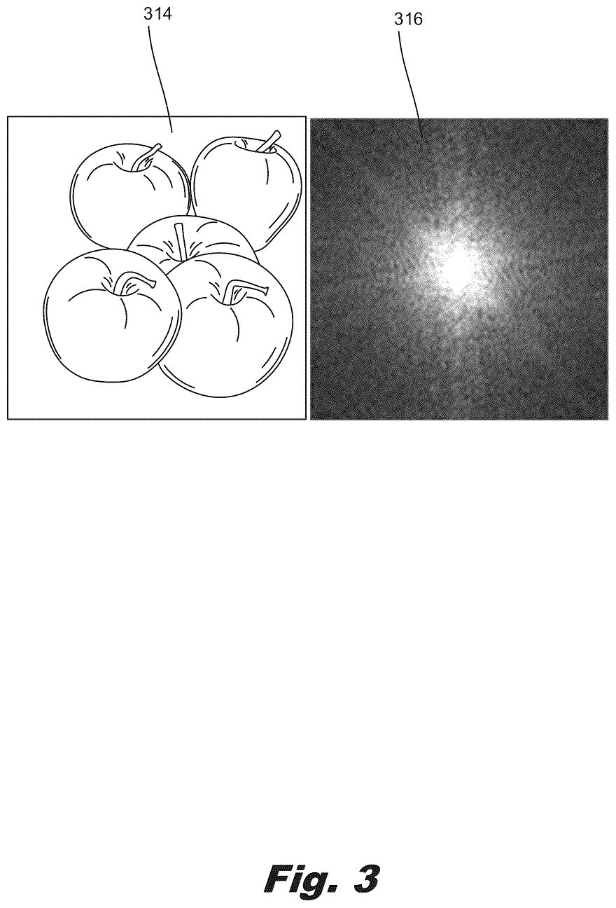

FIG. 1 is a block diagram of a wearable XR system (100) for deconstructing a hologram pattern, according to an example of the principles described herein. In an example, the hologram pattern may represent a pattern that results from the Fourier transformation of images, video, or other content presented on a host computing device. That is, a host computing device may be used to present any variety of content to a user including images, video, word processing files, or any other type of file. Performing a Fourier transformation on this content encrypts the content into a format that is unreadable by humans. FIG. 3 depicts an image of an apple and its hologram pattern. From the hologram pattern, a user would not be able to discern that the original image is of an apple.

Accordingly, the Fourier transform of an image, video, or other content represents a way to encode, encrypt, or otherwise obfuscate the original content. The present specification leverages this encoding/encryption to ensure privacy of content displayed on a display device, such as a monitor, of a host computing device.

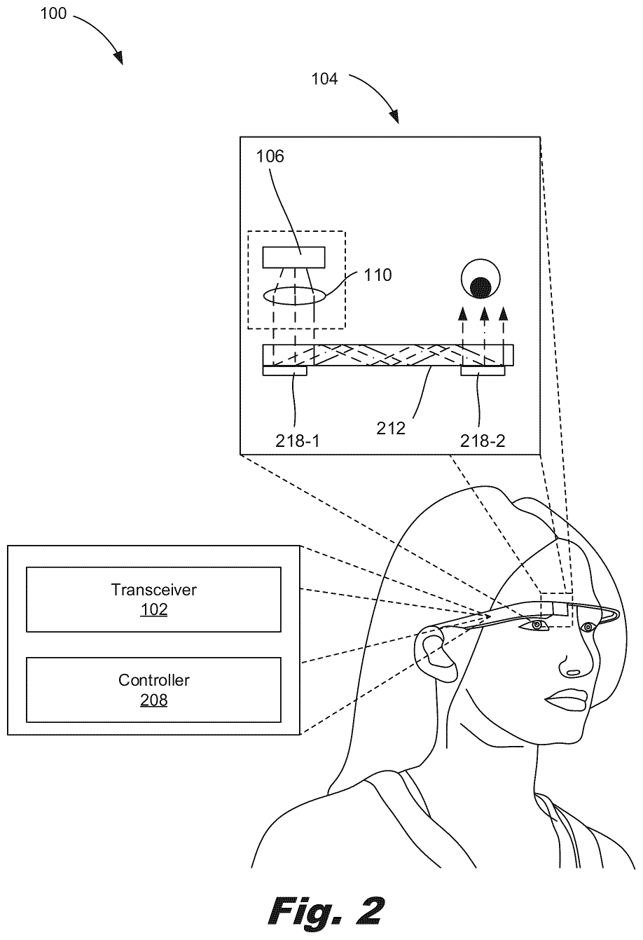

In an example, the wearable XR system (100) is a pair of XR spectacles as depicted below in FIG. 2. In another example, the wearable XR system (100) may include an XR headset to be worn on a head of the user. Such an XR headset may cover the eyes of the user to present the visual information in an enclosed environment formed by the XR headset housing and the user's face. As with the transparent lens, the XR headset may be of a variety of types including a projector-based wearable XR system or a light-emitting display system.

As described above, the term XR encompasses, VR, MR, and AR such that an extended reality HMD encompasses VR HMDs, MR HMDs, and AR HMDs. The content that is displayed on the wearable XR system (100) may be provided by a host computing device such as a personal computer (PC), all-in-one device, gaming console, or the like. Accordingly, the wearable XR system (100) includes a transceiver (102) to receive, from the host computing device, a hologram pattern of original content to be displayed. This original content may take a variety of forms. For example, the original content may be a static image such as a photograph, computer-generated image, a word processing document, or any other form of static content. In another example, the original content may be a video stream, which is a sequence of still images.

In either example, the host computing device, or in some examples the wearable XR system (100) converts the original image into a multi-dimensional hologram pattern representation of the content. For example, a computing device screen is made up of individually addressable pixels, each of which have a particular pixel value defining the color at that location. In other words, content of a screen is represented as a two-dimensional matrix of color numbers. To generate the encrypted form of content, a one-dimensional Fourier transformation may be applied to each column of the two-dimensional array to generate a matrix of one-dimensional Fourier coefficients. A second Fourier transformation may be applied to the rows of the two-dimensional array. However, in this second Fourier transformation operation, rather than performing the Fourier transformation on the color numbers, the second Fourier transformation is performed on the one-dimensional Fourier coefficients. As a result, there is a matrix of 2-dimensional Fourier coefficients which generates a pattern, also referred to as a hologram pattern, which is a pattern of colored pixels in a format that is indiscernible to a human. The Fourier transformation produces a complex number valued output (i.e., with both a real and imaginary component) which may represent the magnitude and phase.

Fourier transformations are used in a variety of applications including image filtering, image enhancement, image analysis, image reconstruction, and image compression. In the present application, the Fourier transformations are used to encode data to be deconstructed later for viewing by authorized users.

In image processing, it may be that just the magnitude of the Fourier transformation is recorded as float values, as the magnitude contains information of the geometric structure of the spatial domain original content. However, in the present application where the Fourier image is re-transformed back into the original, spatial domain, content, the float values of the Fourier transformation may preserve both the magnitude and phase of the Fourier transformation image.

As such, the present wearable XR system (100) includes a transceiver (102) which may wirelessly communicate with a host computing device, which host computing device generates the hologram pattern of the content to be displayed on the wearable XR system (100). That is, the host computing device may display content on a monitor. The host computing device may perform a Fourier transformation of this content, and wirelessly transmit the hologram pattern generated by the Fourier transformation to the wearable XR system (100) by way of the transceiver (102).

In addition to receiving information, the transceiver (102) may transmit information to the host computing device. Specifically, the transceiver (102) may transmit an authentication key, such as a universally unique identifier (UUID), which authorizes deconstruction of the Fourier transformation into the original content. That is, as described below the wearable XR system (100) includes components to deconstruct the Fourier transformation. If the wearable XR system (100) or user is authenticated, these hardware components may be activated. By comparison, if the wearable XR system (100) or the user is not authenticated, these hardware components may be deactivated or the wearable XR system (100) may otherwise be rendered incapable of displaying decoded original content. The transceiver (102) may communicate via a variety of protocols. For example, the transceiver (102) may be a Wi-Fi transceiver, a Bluetooth® transceiver, or any other near-field transceiver, or wide range transceiver.

The wearable XR system (100) also includes a display unit (104) to present 1) the encoded transformation of the original content and 2) the decoded original content. In an example, the display unit (104) includes a pattern lens (110) to display the hologram pattern in front of an RGB light source (106). In this example, the original content may be presented as a hologram through the XR spectacles.

The display unit (104) further includes an RGB light source (106) to emit light towards the hologram pattern to deconstruct the hologram pattern to present the original content. The RGB light source (106) includes a red-colored light element, a blue-colored light element, and a green-colored light element, each of which may be light emitting diodes (LEDs). Each of these light elements emit energy within a respective wavelength. Each of the different light waves has a different optical wavefront and phase. As each wavefront passes through the hologram pattern, it interacts with the associated colored beams to form R, G, and B sub-frame images respectively which are then combined into one multi-color, or full color, frame image. Put another way, the LED light interacts with the hologram pattern in an interference to form the original content.

Based on this interaction of a particular color wavelength with the hologram, a version of the original content in that particular color is generated. That is, the RGB light source (106) emits light through the hologram pattern to transform the field distribution (e.g., the hologram pattern) back in the spatial domain and produces an image in the image plane.

For example, given original content of an image of apples, a red light passing through the hologram pattern will generate an image of the apples with a red cast. Similarly, a blue light passing through the hologram pattern will generate an image of the apples with a blue cast and a green light passing through the hologram pattern will generate an image of the apples with a green cast. Each of these color cast images may be combined to form a full color representation of the image of the apples.

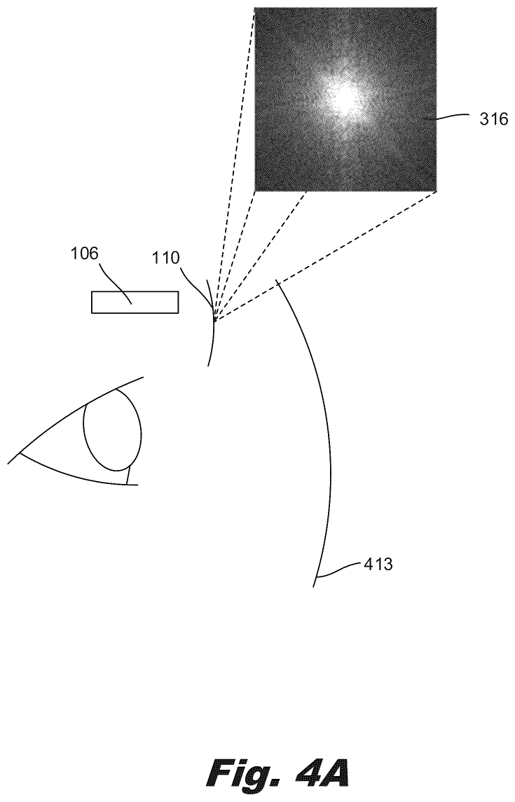

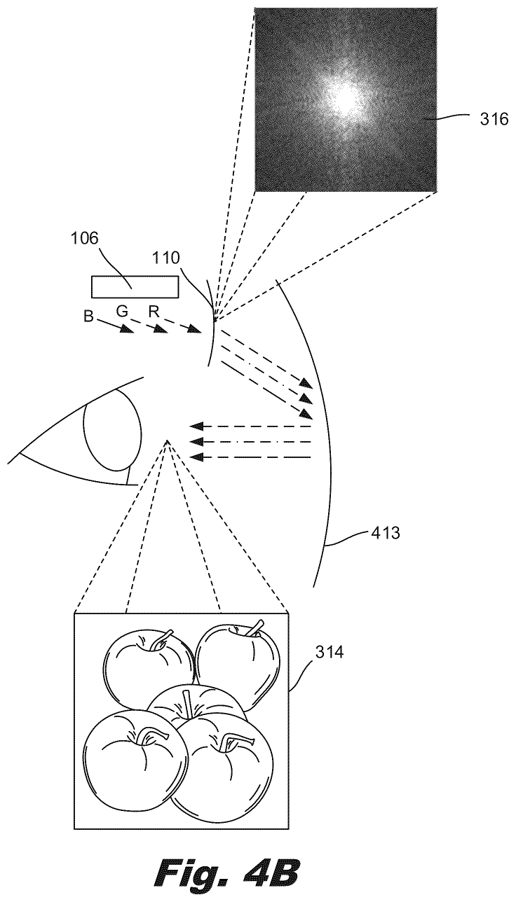

The display unit (104) also includes an image director (107). The image director (107) directs light passing through the pattern lens (110) towards the pupils of the user and facilitates the generation of the original content as a hologram. As depicted in FIG. 2, the image director (107) may be a projector and as depicted in FIGS. 4A, 4B, and 6, the image director (107) may be a transparent lens.

For example, the transparent lens may be a curved mirror display or a waveguide display. A curved mirror display may present the digital information by projecting an image onto a curved surface, i.e., the lens. In a waveguide display, projected light is bent in front of the eyes of the user to display a visual field. Light may be sent through the transparent lens (which may be glass or plastic) that is to reflect the light along the material. In this example, the light may bounce of a waveguide to a portion of the lens that is in front of the eye of the user. While reference is made to certain types of transparent spectacle displays, other types may be implemented in accordance with the principles described herein.

As such, the present wearable XR system (100) provides privacy for content displayed on a host computing device by first encrypting the visual content as a hologram pattern. Accordingly, any passersby would not be able to ascertain, discern or observe the visual content presented on the host computing device screen. This same hologram pattern is transmitted to a wearable XR system (100). The hologram pattern is decoded upon authorization of the wearable XR system (100) and/or a user of the wearable XR system (100). As such, an unauthorized user, even if able to view the hologram pattern, would not be able to discern the original content as the RGB light source (106) may not be activated for an unauthorized user.

FIG. 2 depicts a user wearing the wearable XR system (100) for deconstructing a hologram pattern, according to an example of the principles described herein. As described above, the wearable XR system (100) may take a variety of forms. In the example depicted in FIG. 2, the wearable XR system (100) takes the form of XR spectacles. In this example, the RGB light source (106) is integrated into the frame of the spectacles.

As described above, the RGB light source (106) decodes, or decrypts the hologram pattern by emitting RGB light towards the hologram pattern as projected on the pattern lens (110). Accordingly, the display unit (104) includes a pattern lens (110) on which the encoded transformation (e.g., the hologram pattern) is presented. The pattern lens (110) may take a variety of forms. For example, the pattern lens (110) may be an emitting panel, such as a light-emitting diode (LED) panel, or an organic LED (OLED) panel. In another example, the pattern lens (110) may be a lit transparent panel such as a liquid crystal display (LCD) panel. In yet another example, the wearable XR system (100) may include a projector to project the hologram pattern onto the pattern lens (110). With the pattern lens (110) and the RGB light source (106) in this configuration, the RGB light source (106) may emit RGB Light onto the pattern lens (110) to deconstruct the original content from the hologram pattern.

As described above, the display unit (104) also includes an image director (107), which in the example depicted in FIG. 2 is a projector (212) which re-directs the original content towards the user. The projector (212) be made of a light reflecting material such as glass or plastic and may include components to aid in the generation of the holographic decoded original content. For example, the projector (212) may include a number of holographic optical elements (218-1, 218-2) which are optical components such as mirrors, lenses, directional diffusers that aide in generating holographic images using principles of diffraction. The type and shape of holographic optical elements (218) implemented depend on the hardware and energy beams. Light from the pattern lens (110) is reflected towards the projector (212) where it is acted upon by the holographic optical elements (218) such that a hologram is generated and presented to the eyes of the user as depicted in FIG. 2.

In addition to those components previously mentioned, the wearable XR system (100) may include additional components. For example, the wearable XR system (100) may include a controller (208) to selectively activate the RGB light source (106) responsive to authentication of the wearable XR system (100) and/or a user of the wearable XR system (100). That is, the RGB light source (106) is what deconstructs, or decomposes, the hologram pattern into the original content. As such, selective activation ensures that the RGB light source (106) decodes the hologram pattern just when an authorized viewer is wearing the XR spectacle and prevents decoding or deconstruction of the hologram pattern when an unauthorized user is wearing the wearable XR system (100). In one example, the controller (208) may include a switch to open or close a circuit to the RGB light source (106) based on the user authentication. As depicted in FIG. 2, the transceiver (102) and controller (208) may be integrated into the frame of the spectacles.

FIG. 3 depicts a hologram pattern (316) of original content (314) to be presented on the wearable XR system (100), according to an example of the principles described herein. As described above, the hologram pattern (316) represents the frequency domain representation of the original content (314) which original content (314) is represented in the spatial domain. In the example depicted in FIG. 3, the original content (314) is a static image of apples. A one-dimensional Fourier transformation may be applied to each column of pixels of the two-dimensional array to generate a matrix of one-dimensional Fourier coefficients. A second Fourier transformation may be applied to the rows of the two-dimensional array. However, in this second Fourier transformation operation, rather than performing the Fourier transformation on the color numbers, the second Fourier transformation is performed on the one-dimensional Fourier coefficients. From this, a hologram pattern (316) is obtained, which hologram pattern (316) is deconstructed or decomposed when exposed to RGB light from the RGB light source (106). That is, the light source passes through the hologram pattern (316) and interference of the light with the hologram pattern (316) generates the original content.

FIGS. 4A and 4B, depict a wearable XR system (100) for the deconstruction of a hologram pattern (316), according to an example of the principles described herein. In the example depicted in FIGS. 4A and 4B, the image director (107) is a transparent lens (413) which re-directs light passing through the pattern lens (110) towards the user as depicted in FIG. 4B.

Specifically, FIG. 4A depicts the wearable XR system (100) wherein the RGB light source (106) is inactive. The RGB light source (106) may be inactive either prior to authentication of the user and/or wearable XR system (100) or after identification of an unauthorized user. As described above, without such RGB light source (106) activation, the hologram pattern (316) is not decoded. Accordingly, there may be no presentation of the original content.

FIG. 4A also depicts the positional arrangement wherein the hologram pattern (316) is presented on the pattern lens (110) which may be a display panel such as an LCD, LED, or OLED panel or may be a surface on which a projector projects the hologram pattern (316).

FIG. 4B depicts the wearable XR system (100) following user authentication. That is, responsive to authentication of the user and/or wearable XR system (100), the controller (208) may activate the RGB light source (106) such that each light element emits an energy beam with a particular wavelength and phase. As described above, the interaction of each differently-colored energy beam with the hologram pattern (316) generates a different wavefront which interacts with the hologram pattern (316) to generate a colored version of the original content. FIG. 6 depicts the various color images of the original content.

The color images that are generated constructively interfere with one another such that the original content (314) is reproduced as depicted in FIG. 4B. As depicted in FIG. 4B, the red, green, and blue light elements may be emitted simultaneously from the RGB light source (106). However, as depicted in FIG. 6, these elements may emit light sequentially.

As described above, the transparent lens (413) may reflect the light rays towards the eyes of the user, which may result in a hologram representation of the original content (314) being presented in a hologram plane.

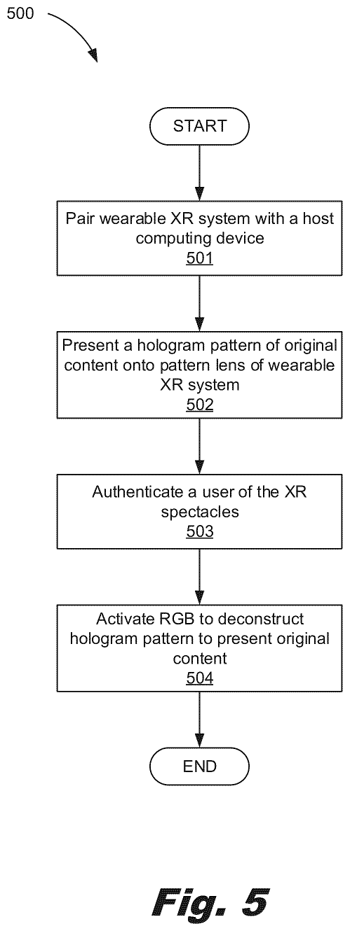

FIG. 5 depicts a flowchart of a method (500) for deconstructing a hologram pattern (316), according to an example of the principles described herein. According to the method (500), a wearable XR system (100) which may be a pair of XR spectacles, an enclosed HMD, or other wearable XR system (100) is paired (block 501) with a host computing device. Such a pairing may be carried out via a handshake operation, or other pairing operation, between the wearable XR system (100) and the host computing device. Specifically, via the transceiver (102) and other hardware components of the wearable XR system (100) and the host computing device, an established communication path may be established wherein the host computing device can send and receive data from the wearable XR system (100).

Following pairing, the hologram pattern (316) of original content may be presented (block 502) onto a pattern lens (110) of the wearable XR system (100). That is, the hologram pattern (316) may be projected, or sent to a light-emitting or lit pattern lens (110) of the wearable XR system (100).

According to the method (500), a user of the wearable XR system (100) or the wearable XR system (100) may be authenticated (block 503). This may be done in any variety of ways including via transmission of a UUID of the wearable XR system (100), entry of username and password, biometric authentication of the user, or any other variety of authentication (block 503) operations. Responsive to authentication of the user or wearable XR system (100), the RGB light source (106) may be activated (block 504). As described above, doing so deconstructs the hologram pattern (316) to present the original content. That is, the red, green, and blue lighting elements interact with the hologram pattern (316) image to create wavefronts that interact with one another to generate the original content (314) image.

Following deconstruction of the hologram pattern, the original content may be directed towards the user via the image director (107).

As described above, if a user is not authenticated, the RGB light source (106) is not activated, there is no generation of the original content (314). Thus, the present method (500) provides enhanced security of information from potentially malicious or inadvertent viewing by a passerby.

FIG. 6 depicts a wearable XR system (100) for the deconstruction of hologram patterns (316), according to an example of the principles described herein. In this example, rather than simultaneously emitting light, each of the red, blue, and green light elements reflect light sequentially. That is, the light source(s) emit light of different wavelengths corresponding to red, green, and blue light one at a time. As described above, the interaction of each light element with the hologram pattern (316) generates an image of a particular color cast. For example, a red light passing through the hologram pattern (316) will generate an image of the apples with a red cast. Similarly, a blue light passing through the hologram pattern (316) will generate an image of the apples with a blue cast and a green light passing through the hologram pattern (316) will generate an image of the apples with a green cast.

Each light is emitted at a rate such that a user is unable to perceive the different cycles of RGB light. That is, each of the R, G, and B light elements emit red, green, and blue light sequentially at a high rate, quicker than the human eye can discern. Put another way, each of red, green, and blue light are emitted for a sub-frame and combine into one frame to constructively interfere with one another to generate the original content (314).

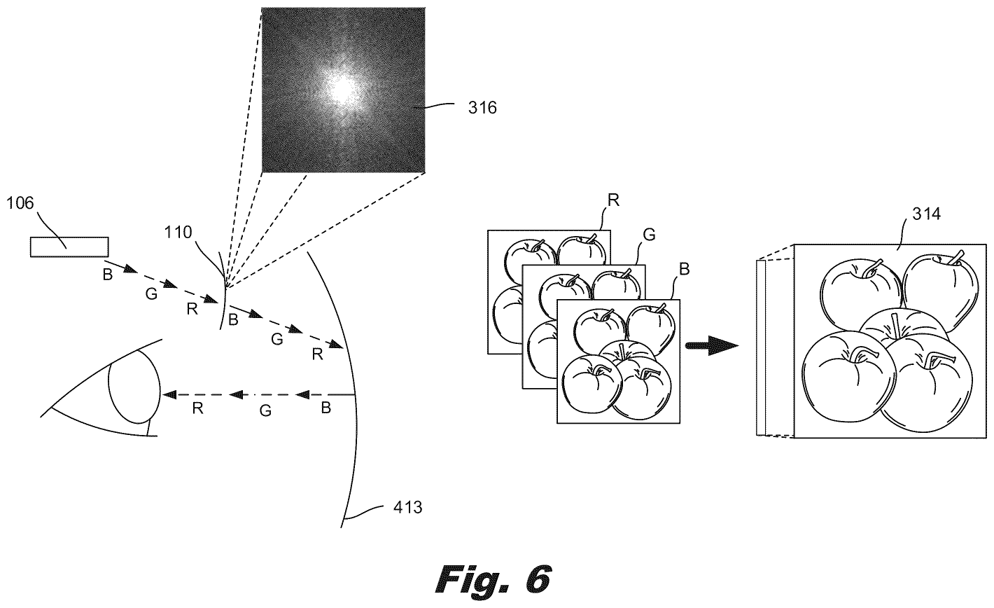

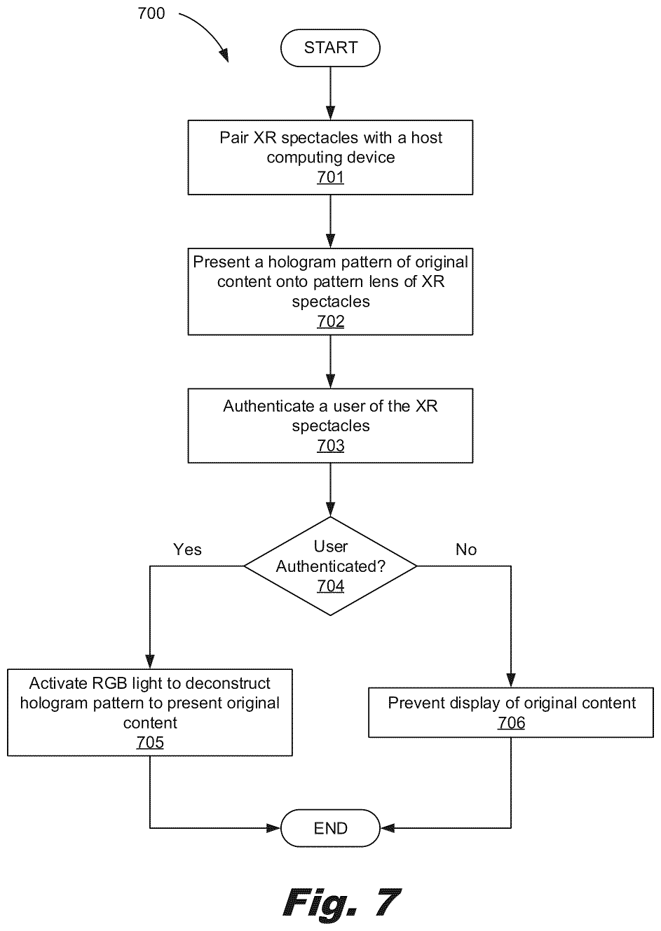

FIG. 7 depicts a flowchart of a method (700) of deconstructing a hologram pattern (316), according to an example of the principles described herein. According to the method (700), a wearable XR system (100) is paired (block 701) with a host computing device and a hologram pattern (316) of original content (314) is presented (block 702) on a pattern lens (110) of the wearable XR system (100). These operations may be performed as described above in connection with FIG. 5.

As described above, the RGB light source (106) may be selectively activated to selectively provide access to the original content (314). Accordingly, the method (700) includes authenticating (block 703) the user of the wearable XR system (100) or authenticating the wearable XR system (100) itself. This may occur in any variety of ways. For example, a user may be prompted to enter a user identification and/or password to authenticate. In another example, the user may be authenticated via biometric markers that may be collected by the wearable XR system (100). For example, the wearable XR system (100) may include a facial recognition system to record and authorize the user based on various biometric markers.

As another example, the wearable XR system (100) itself may be authenticated. For example, the wearable XR system (100) may be associated with a universally unique identifier (UUID). The UUID may be compared against a database of authenticated devices. As such, the method (700) includes determining (block 704) whether the user or wearable XR system (100) is authenticated or not. Responsive to identifying an authenticated user or wearable XR system (100) (block 704, determination YES), the method (700) includes activating (block 705) the RGB light source (106) to deconstruct the hologram pattern (316) to present the original content (314). This may be performed as described above in connection with FIG. 5. By comparison, responsive to identifying an unauthorized user or wearable XR system (100) (block 704, determination NO), the method (700) may include preventing (block 706) the display of content on the wearable XR system (100). Such prevention may take a variety of forms. For example, the wearable XR system (100) may prevent activation of the RGB light source (106). In another example, the wearable XR system (100) may prevent display of the hologram pattern (316). For example, responsive to identification of an unauthorized user, or lack of identification of an authorized user, the wearable XR system (100) may deactivate the projector, or other image-forming apparatus of the wearable XR system (100) such that nothing is displayed on the pattern lens (110).

As such, the present method (700) provides image and/or video content security by authenticating a user and/or wearable XR system (100) prior to activating a component which deconstructs the hologram pattern (316) or reconstructs the original content (314).

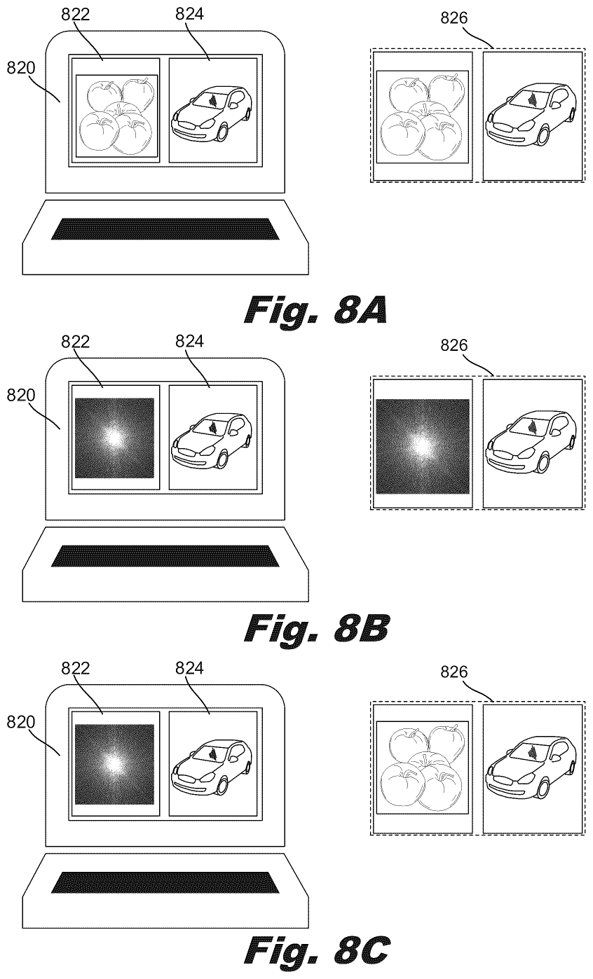

FIGS. 8A-8C depict the various modes of a host computing device (820) and associated wearable XR system (100) displays, according to an example of the principles described herein. As described above, the wearable XR system (100) may display original content that is the same as content presented on the host computing device (820). In this example, the host computing device (820) may generate a hologram pattern (316) for the entire display, or just a region of the display. That is, a host computing device (820) screen may be divided into different regions (822, 824) where a first region (822) includes image/video content that the user desires to maintain private or secure. For example, the first region (822) may include a word processing document for one's business that the user desires to maintain private when in a public setting, such as an airport. A second region (824) by comparison may include a video stream of a local news channel that does not include sensitive or confidential information. Accordingly, the implementation of a hologram pattern (316) to ensure the privacy/security of content may be applied to a sub-region of the display device.

Such a region that is selected for privacy operations may be based on a user-drawn boundary. For example, the user may manually draw a box around a region of a screen wherein pixels inside the boundary are subject to the afore-mentioned Fourier transformation. In another example, the region that is subject to Fourier transformation encoding may be a selected window on the host computing device (820). In either case, the region of the host computing device (820) that is targeted for security may be subject to the Fourier transform while the other regions, i.e., the second region (824), is projected or displayed on the wearable XR system (100) in an un-transformed format as depicted in FIGS. 8A-8C by the image of the car being untransformed in each mode.

FIG. 8A also depicts a view (826) through the wearable XR system (100) where the host computing device (820) is in a sharing mode. In this mode, the content on the host computing device (820) is mirrored on, or viewable through, the wearable XR system (100).

FIG. 8B depicts the host computing device (820) in a privacy mode, prior to authentication of a user. In this mode, a particular region, i.e., the first region (822) has been targeted for encoding/encryption. Accordingly, the first region (822) is Fourier transformed to obfuscate the original content presented in the first region (822). FIG. 8B also depicts the view (826) that would be seen by an authenticated user prior to authentication wherein the first region (822) is encrypted.

FIG. 8C depicts the host computing device (820) in a privacy mode, following authentication of the user and/or wearable XR system (100). As depicted above, responsive to authentication, the RGB light source (106) is activated, such that the Fourier transformation that is projected onto the wearable XR system (100) is deconstructed to present the original content as depicted in the view (826) through the wearable XR system (100) in FIG. 8C.

Note that as depicted in FIG. 8C, the host computing device (820) maintains the hologram pattern (316) of the encoded region such that passersby do not view the original content, either inadvertently or maliciously. Accordingly, the present system ensures that passersby who may be in viewing distance of the host computing device (820) do not see the secure image/video and unauthenticated users of a paired wearable XR system (100) also do not see the secure image/video and just authenticated users of paired wearable XR system (100) can view the original content on account of the interference of the activated RGB light elements with the Fourier transformation to reconstruct the original content on the wearable XR system (100).

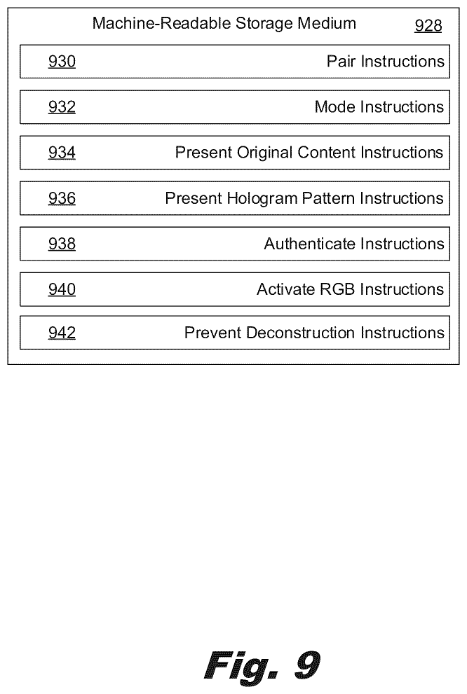

FIG. 9 depicts a non-transitory machine-readable storage medium (928) for deconstructing a hologram pattern (316), according to an example of the principles described herein. To achieve its desired functionality, the wearable XR system (100) includes various hardware components. Specifically, the wearable XR system (100) includes a processor and a machine-readable storage medium (928). The machine-readable storage medium (928) is communicatively coupled to the processor. The machine-readable storage medium (928) includes several instructions (930, 932, 934, 936, 938, 940, 942) for performing a designated function. In some examples, the instructions may be machine code and/or script code.

The machine-readable storage medium (928) causes the processor to execute the designated function of the instructions (930, 932, 934, 936, 938, 940, 942). The machine-readable storage medium (928) can store data, programs, instructions, or any other machine-readable data that can be utilized to operate the wearable XR system (100). Machine-readable storage medium (928) can store machine-readable instructions that the processor of the wearable XR system (100) can process, or execute. The machine-readable storage medium (928) can be an electronic, magnetic, optical, or other physical storage device that contains or stores executable instructions. Machine-readable storage medium (928) may be, for example, Random-Access Memory (RAM), an Electrically Erasable Programmable Read-Only Memory (EEPROM), a storage device, an optical disc, etc. The machine-readable storage medium (928) may be a non-transitory machine-readable storage medium (928).

Referring to FIG. 9, pair instructions (930), when executed by the processor, cause the processor to pair a wearable XR system (100) with a host computing device (820). Mode instructions (932), when executed by the processor, cause the processor to, determine a mode of the host computing device (820). Present original content instructions (934), when executed by the processor, cause the processor to, responsive to the host computing device (820) being in a sharing mode, present original content (314) of a host computing device (820) on the wearable XR system (100). Present hologram pattern instructions (936), when executed by the processor, cause the processor to, responsive to the host computing device (820) being in a privacy mode, present a hologram pattern (316) of the original content on a pattern lens (110). Authenticate instructions (938), when executed by the processor, cause the processor to authenticate a user of the wearable XR system (100) responsive to the host computing device (820) being in a privacy mode.

Activate RGB instructions (940), when executed by the processor, cause the processor to, activate a RGB light source (106) responsive to authentication of the user. The RGB light source (106) emits light towards the hologram pattern (316) to deconstruct the hologram pattern (316) to present the original content. Prevent deconstruction instructions (942), when executed by the processor, cause the processor to prevent deconstruction of the hologram pattern (316) of the original content responsive to identifying an unauthenticated user.

In summary, such a system, method, and machine-readable storage medium may, for example, 1) provide security and access rights to information displayed on a host computing device via a wearable XR system, 2) allow for customized selection of content to be encoded, 3) does not limit the viewing angle of secured content; 4) provide for both secured and unsecured content presentation on a single computing device screen; and 5) prevent unauthorized XR systems from viewing the encoded data. However, it is contemplated that the devices disclosed herein may address other matters and deficiencies in a number of technical areas, for example.

What is claimed is:

1. A wearable extended reality (XR) system, comprising:
a transceiver to receive, from a host computing device, a hologram pattern of original content to be displayed;
a display unit comprising:
a pattern lens to display the hologram pattern in front of a red, green, blue (RGB) light source;
the RGB light source to emit red, green, and blue light towards the hologram pattern to deconstruct the hologram pattern to present the original content; and
an image director to direct decoded original content towards a user of the wearable XR system.

2. The wearable XR system of claim 1, further comprising a controller to selectively activate the display unit responsive to authentication of:
the wearable XR system; or
the user of the wearable XR system.

3. The wearable XR system of claim 1, wherein:
the display unit comprises XR spectacles; and
the image director is a transparent lens to reflect the decoded original content towards the user of the wearable XR system.

4. The wearable XR system of claim 1, wherein:
the display unit comprises XR spectacles; and
the image director is a projector to direct the decoded original content towards the user of the wearable XR system.

5. The wearable XR system of claim 1, wherein the red, green, and blue light are emitted simultaneously from the RGB light source.

6. The wearable XR system of claim 1, wherein the red, green, and blue light are emitted sequentially from the RGB light source.

7. The wearable XR system of claim 1, wherein the hologram pattern of the original content is a Fourier pattern of the original content.

8. A method comprising:
pairing extended reality (XR) spectacles with a host computing device;
presenting a hologram pattern of original content onto a pattern lens of the XR spectacles;
authenticating a user of the XR spectacles; and
responsive to authentication of the user, activating a red, blue, green (RGB) light source to emit light towards the hologram pattern to deconstruct the hologram pattern to present the original content.

9. The method of claim 8, wherein the original content is the same as content presented on the host computing device.

10. The method of claim 9, wherein the hologram pattern pertains to a region of a host computing device display while other regions of the host computing device display are un-transformed.

11. The method of claim 10, wherein the region comprises an area within a user-drawn boundary.

12. The method of claim 10, wherein the region comprises a selected window on the host computing device display.

13. The method of claim 8, further comprising, responsive to identifying an unauthorized user:
preventing activation of the RGB light source; or
preventing display of the hologram pattern.

14. A non-transitory machine-readable storage medium encoded with instructions executable by a processor, the machine-readable storage medium comprising instructions to:
pair extended reality (XR) spectacles with a host computing device;
determine a mode of the host computing device;
responsive to the host computing device being in a sharing mode, present original content of the host computing device on the XR spectacles;
responsive to the host computing device being in a privacy mode:
present a hologram pattern of the original content on a pattern lens of the XR spectacles;
authenticate a user of the XR spectacles; and
responsive to authentication of the user, activate a red, blue, green (RGB) light source to emit light towards the hologram pattern to deconstruct the hologram pattern to present the original content; and
responsive to identifying an unauthenticated user, preventing deconstruction of the hologram pattern of the original content.

15. The non-transitory machine-readable storage medium of claim 14, wherein the original content to be displayed is a video stream.
